(19) United States
(12) Patent Application Publication
(10) Pub. No.: US 2004/0025185 A1
(43) Pub. Date: Feb. 5, 2004

(54) Digital video jukebox network enterprise system

(76) Inventors: John Goci, Wayne, MI (US); Thomas C. Gubatayao, Davis, CA (US)

Correspondence Address: DYKEMA GOSSETT PLLC, 39577 WOODWARD AVENUE, SUITE 300, BLOOMFIELD HILLS, MI, 48304-5086, US

(21) Appl. No.: 10/423,553

(22) Filed: Apr. 25, 2003

Related U.S. Application Data
(63) Continuation-in-part of application No. 10/135,218, filed on Apr. 29, 2002.
(60) Provisional application No. 60/430,389, filed on Dec. 2, 2002.

(51) Int. Cl. H04N 7/173; H04N 7/16

(52) U.S. Cl. 725/92; 725/93; 725/115; 725/145

(57) ABSTRACT

An integrated video jukebox and entertainment management system for a premises comprises a video jukebox server providing a set of video selections customized to a predetermined commercial enterprise for the premises. A large-area display system is deployed in the premises. A plurality of jukebox clients are deployed in the premises and networked with the jukebox server. A payment acceptor is coupled to at least one of the jukebox clients for establishing credits for accessing the video selections. A touch screen input device is coupled to the one jukebox client for providing a user interface wherein a user is able to browse the set of video selections and choose a desired video selection for display by the large-area display system. The one jukebox client transmits a request to the jukebox server for displaying the desired video selection if sufficient credits are established.

### RELATED APPLICATIONS

This is a continuation-in-part (CIP) of U.S. application Ser. No. 10/135,218 filed Apr. 29, 2002, now pending, and claims the benefit of U.S. provisional patent application Serial No. 60/430,389 filed Dec. 2, 2002, both hereby incorporated by reference in their entirety.

### BACKGROUND OF THE INVENTION

The present invention relates in general to a digital video jukebox system, and, more specifically, to integrating a video jukebox system with a commercial enterprise to increase customer enjoyment of video services while reducing operating costs of the commercial enterprise.

Jukeboxes in commercial establishments for playing selected audio recordings are widespread, but have become less numerous in recent years. During the same time period, combined audio and video (multimedia) content has increased in popularity, e.g., music videos. While the rise in music videos was originally associated with cable television, the Internet has also become an important distribution channel of music videos and as well as other multimedia content such as movies and live broadcasting.

Computer kiosks are being deployed in public places such as airports for allowing persons to access Internet applications (e.g., e-mail and web browsing). The kiosks provide a self-contained computer system such that a user can obtain a private network session. Typically, the user may be charged a fee to use the computer kiosk. Although most current uses of these systems relate to business applications (e.g. mobile office), entertainment and other applications are available through web browsing. Kiosk use for entertainment applications has been limited by cost, availability, and convenience.

Public restaurants, taverns, nightclubs, or other commercial enterprises often provide audio or multimedia entertainment within their establishment, which may be recorded, live, or a combination of the two (e.g., karaoke or live DJ's). Video systems often include large projection screens and/or television monitors for presenting sports coverage or music videos, for example. The same projection and sound reproduction equipment may be used for prerecorded, live broadcast, and live performers entertainment, but the organization, control, and delivery of an overall entertainment experience has been difficult and costly to manage.

It is also known to play commercials, advertisements or the like when the playlist of user selected songs is empty, as seen by reference to U.S. Pat. No. 5,872,747 to Johnson. Johnson discloses that the empty condition typically occurs at the times when fewer customers are in the business establishment, such as off-peak hours, and thus it would be desirable to have a system that provides the ability to play audio commercials or announcements at predetermined times, regardless of whether user selections are in the queue. Thus, while Johnson appears to disclose a system for scheduling audio commercials in an audio “jukebox” at predetermined times of the day, such scheduling is fixed well in advance of the time such commercials are actually contemplated for playback, and appears limited to audio CDs, since this is the mechanism used for implementing the approach in Johnson. This inflexibility in scheduling (i.e., adding or deleting a commercials, adjusting the time of day for playback, etc.) and the type of media presents challenges in maximizing advertising or commercial revenue income for the business establishment.

It is also known to provide security for audiovisual works embodied in digital form, as seen by reference to U.S. Pat. No. 6,330,670 B1 issued to England et al. entitled “DIGITAL RIGHTS MANAGEMENT OPERATING SYSTEM.” England et al. disclose Microsoft Corporation's Digital Rights Management (DRM) system. DRM teaches encrypting protected (i.e., via copyright or other intellectual property right) content by providing a separate license containing the key to decrypt each piece of content. While the license including the key may provide limitations as to the time duration for which the license is valid or the number of times the protected content may be reproduced, a significant limitation of DRM is that once authorized, such license (and key) is stored locally on the machine. DRM is not intended, nor is it effective in, preventing content misuse, for example, if a digital video jukebox is stolen because the licenses containing the keys are stored on a local hard-drive, and could be stolen with the encrypted content.

It is also known to provide personal-computer-based media players, such as WINAMP or the like that allow generation and playback of a user-selected playlist, and even allow playback operation in accordance with a randomly generated playlist. However, neither WINAMP nor other media players appear to allow exclusionary mechanisms (i.e., to tailor what's available for inclusion on a playlist). U.S. Pat. No. 6,192,340 B1 to Abecassis entitled “INTEGRATION OF MUSIC FROM PERSONAL LIBRARY WITH REAL-TIME INFORMATION” disclose a multimedia device capable of being programmed according to “schedule preferences,” which refers to a time based preference or preferences, such as when certain audio, music, and/or information is to be played. Audio content is included in an audio library. These schedule preferences can be combined with music preferences, such as the type of music like classical or rock music, so that at the preset times, the user gets the kind of music wanted. However, none of the foregoing provide the ability to allow a proprietor of a business establishment, operating a jukebox, to restrict the audiovisual material available for selection by the patrons (i.e., the end users). For example, some types of “slow” rhythm audiovisual materials may be undesirable during “dance” hours at business establishment, when upbeat materials are desired. It would be advantageous to provide a profiling mechanism where the proprietor of a jukebox can exclude what material is available for selection (e.g., pay for play) by the patrons.

There is therefore a need to provide a jukebox that minimizes or eliminates one or more of the problems or shortcomings set forth above.

### SUMMARY OF THE INVENTION

The present invention provides a video entertainment system integrated with a commercial enterprise, resulting in advantages of lower overall cost to the business to enterprise, increased customer satisfaction, and increased revenues.

In one aspect of the invention, an integrated video jukebox and entertainment management system for a premises comprises a video jukebox server providing a set of video selections customized to a predetermined commercial enterprise for the premises. A large-area display system is deployed in the premises. A plurality of is jukebox clients are deployed in the premises and networked with the jukebox server. A payment acceptor is coupled to one of the jukebox clients for establishing credits for accessing the video selections. A touch screen input device is coupled to the one jukebox client for providing a user interface wherein a user is able to browse the set of video selections and choose a desired video selection for display by the large-area display system. The one jukebox client transmits a request to the jukebox server for displaying the desired video selection if sufficient credits are established.

In another aspect of the invention, a jukebox configured for dynamic scheduling of commercials, advertisements, announcements or the like is provided. The jukebox includes a database configured to store a plurality of audiovisual items in digital form. A first portion of the database includes advertisements, commercials, announcements and the like. The jukebox further includes a control unit coupled to the database. The control unit has a first (administrator) interface configured for facilitating selection of an item from the first portion of the database and for allowing specification of a time for reproduction of the selected audiovisual item (commercial). The control unit further includes a second (end-user) interface configured to allow selection from a second portion of the database of audiovisual items, different from the first portion, for subsequent reproduction (e.g., entertainment, music videos, etc.). The control unit is further configured to reproduce the selected audiovisual item (e.g., a commercial, advertisement, announcement or the like) at approximately the specified time.

A method for enforcing content security for a jukebox, and a jukebox having “library profiling” are also presented.

### BRIEF DESCRIPTION OF THE DRAWINGS

FIG. 1 is a block diagram showing the digital video jukebox network deployed in a premises.

FIG. 2 is a flowchart showing a method of operating the jukebox network of FIG. 1.

FIG. 3 is a flowchart showing a method for identifying selections within a video jukebox server.

FIG. 4 is a front view of a first screen of a touch screen user interface for a video jukebox client.

FIG. 5 is a front view of a second screen of a touch screen user interface for a video jukebox client.

FIG. 6 is a block diagram showing a video jukebox server in greater detail.

FIG. 7 is a block diagram showing a video jukebox client in greater detail.

FIG. 8 is a simplified block and diagrammatic view of a second preferred embodiment according to the present invention.

FIG. 9 is block diagram view showing, in greater detail, an operating system (OS) drive shown in diagrammatic form in FIG. 8.

FIG. 10 is a block diagram view showing, in greater detail, a media drive shown in diagrammatic form in FIG. 8.

FIG. 11 is block diagram view showing a header in accordance with the present invention.

FIG. 12 is a timing diagram of exemplary profiles in accordance with the present invention.

FIG. 13 is block diagram view showing, in greater detail, the control unit of FIG. 8.

FIG. 14 is simplified flowchart of an authentication method in accordance with the present invention.

FIG. 15 is a simplified flowchart of a player process in accordance with the present invention.

FIG. 16 is a simplified flowchart of a task manager process in accordance with the present invention.

### DETAILED DESCRIPTION OF PREFERRED EMBODIMENTS

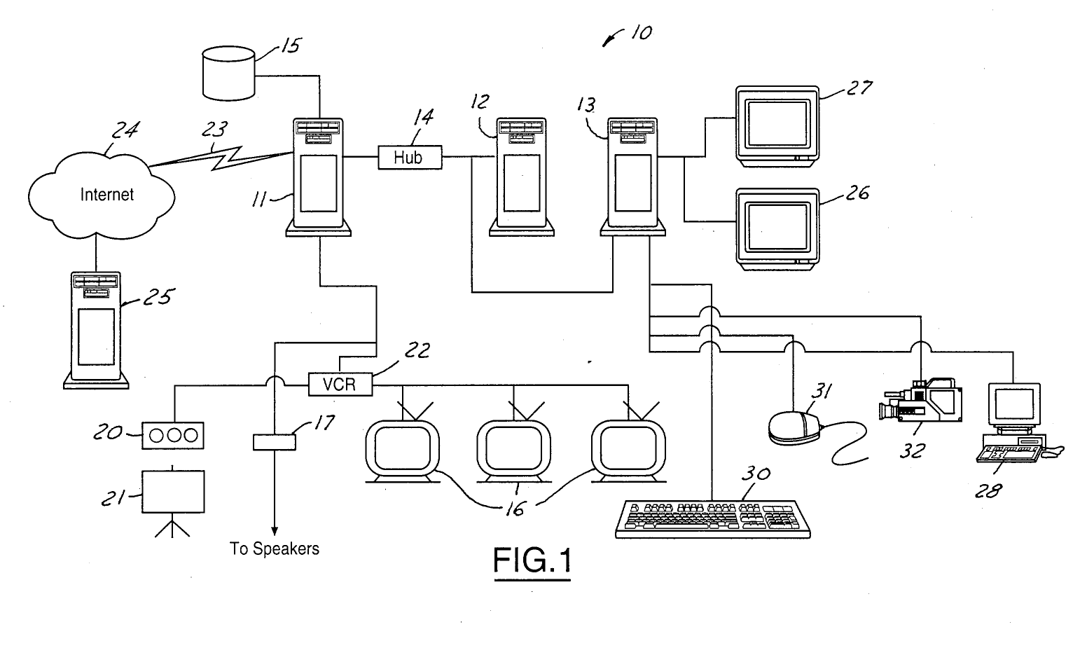

Referring to FIG. 1, a digital video jukebox network 10 is organized in a server-client architecture including a jukebox server 11 and one or more jukebox clients. Two jukebox clients 12 and 13 are shown, but any desired number of clients can be deployed within the premises serviced by network 10 in order to make the jukebox network available to customers of the commercial enterprise (e.g., a client at each table in a nightclub). An Ethernet hub 14 or the like connects server 11 to clients 12 and 13.

Jukebox server 11 may be coupled to several sources of multimedia content including, for example, a removable hard drive 15. The multimedia content may include digital video selections (e.g., music videos, movies, movie trailers, advertisements, announcements, or any other customized audio-visual material desired by the commercial enterprise) and digital audio (e.g., music without accompanying video). The multimedia content may preferably be stored in a compressed format as is known in the art. By providing the multimedia content on removable hard drives, a jukebox service provider can customize and easily update the multimedia content offered at the premises by swapping out the hard drive. By storing on the hard drive the data of the number of times selections have been played, retrieval of information on the fees due to be paid by the commercial enterprise to the jukebox service provider is also simplified.

Multimedia content from hard drive 15 is retrieved and decoded by jukebox server 11 and then reproduced by a large area display for entertainment of the patrons of the commercial enterprise. This content can also be collected via an Internet connection. The display may include a plurality of television monitors 16, a sound reproduction system 17, a CRT projector 20, and a projection screen 21. If necessary for reformatting of the decoded digital video signals (e.g., into an NTSC format), a reformatting device such as an RF channel modulator 22 (e.g., could be a VCR) may be connected between jukebox server 11 and the display devices.

Audio processing may be done internally in server 11 or may be done in an external sound card 18 (e.g., the Sound Blaster Extigy from Creative Labs, Inc.). A wireless remote control 19 is used to adjust audio parameters (e.g., volume and input source). So that sound reproduction system 17 can be used as a public address system and for performing karaoke, a microphone 33 is connected to sound card 18.

In the event of a media failure or communication failure preventing reproduction of video content, an audio player 34 such as an MP3 player is connected to sound card 18 which can be manually activated when needed. Predetermined audio selections are loaded into player 34 and can be manually selected via its separate interface. In one embodiment, server 11 monitors the most popular video selections requested by customers and downloads corresponding audio files into player 34 so that an appropriate mix of audio selections are available during any potential failure of the video system.

Jukebox server 11 may also receive multimedia content via a network connection 23 (e.g., DSL, dial-up modem, cable modem, or T-1 line) to Internet 24. For example, a video jukebox master server 25 is accessible via Internet 24 for providing downloads of multimedia content as well providing supervisory access by the jukebox service provider. The Internet connection can also be used to provide web browsing activities to users of the jukebox clients, if desired.

The present invention provides flexibility in arranging each jukebox client station with interfaces and peripheral devices matched to the intended use by customers and/or employees of the commercial enterprise. At a first station, for example, jukebox client 13 is connected to a touch screen input device 26. Because of robustness and simplicity of use, a touch screen provides the most preferred method for user interaction with the jukebox network. Touch screen 26 displays menu buttons and selection information and senses screen touches in active menu button areas to initiate various actions. An auxiliary screen 27 is also coupled to jukebox client 13 for local (i.e., individual user station) display of jukebox videos and/or advertisements. In order to obtain payment for jukebox selections, a payment acceptor 28 coupled to jukebox client 13 accepts currency and/or credit cards for establishing jukebox credits for use by a customer.

To support more complex services such as web browsing, a keyboard 30 and a point-and-click graphical user interface device such as a trackball 31 may be coupled to jukebox client 13. A video camera 32 may also be coupled to client 32 for sending video images from the client station to other points within jukebox network 10 or to remote locations via Internet 24.

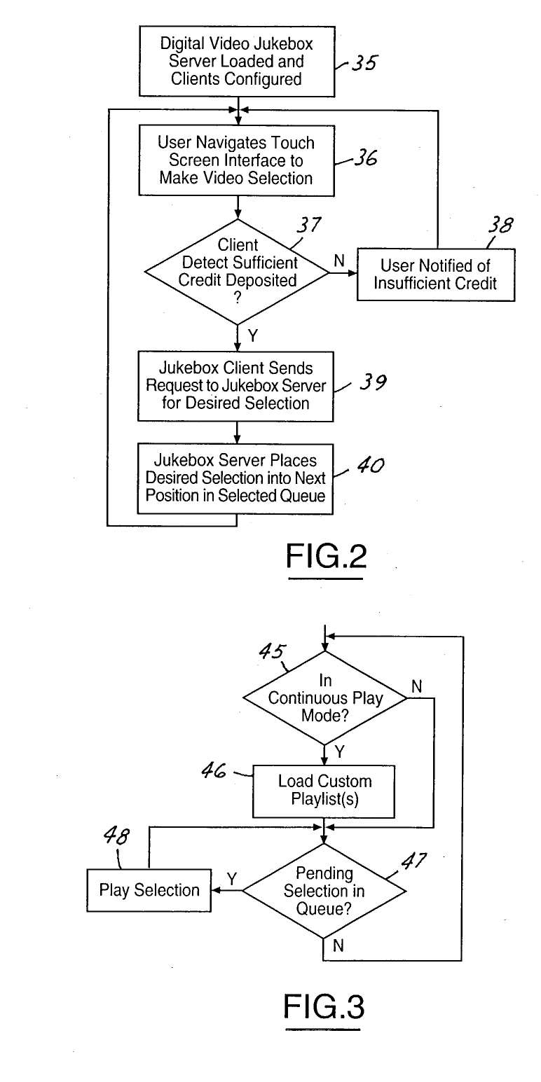

Operation of a preferred embodiment of the present invention is shown in FIG. 2. The digital video jukebox network of the present invention is closely integrated into the commercial enterprise to increase customer satisfaction and lower operating costs.

In step 35, the jukebox server is loaded with customized multimedia content selected for the specific commercial enterprise being served. Instead of expensive live DJ's, multimedia content is chosen with the help of the jukebox service provider to match the desired environment to be provided in the premises. A customized set of video and audio files is loaded on the jukebox server, and a filter may be specified if not all of the files in storage are to be available for selection. Default playlists for general or specialized (e.g., theme night) uses may also be loaded. The jukebox clients are configured to provide a user interface matching the multimedia content available from the server.

In step 36, a user navigates a touch screen interface in order to make a video selection. The jukebox client determines in step 37 whether the user has established sufficient credits that are needed (if any) to demand playing of the desired selection. If there is not sufficient credit, then the jukebox notifies the user that there is insufficient credit (e.g., via a message displayed on the touch screen or the auxiliary display) and a return is made to step 36 to allow the user to establish the necessary credits.

If there is sufficient credit, then the jukebox client sends a request in step 39 to the jukebox server to reproduce the desired selection. In step 40, the jukebox server places the identity of the desired selection into the next position of a selection queue that is maintained by the jukebox server. The selection queue can continuously accept additional selections based on user requests from any jukebox clients.

FIG. 3 illustrates one embodiment of a method within the jukebox server for initiating reproduction of video selections. In step 45, the server determines whether it has been commanded to operate in a continuous play mode. If yes, then at least one customized playlist of the customized multimedia content matched to the commercial enterprise is loaded into the server's selection queue in step 46. If not in continuous play mode, then step 46 is skipped. In step 47, a check is made to determine whether there is a selection pending in the selection queue (e.g., a next selection in a customized playlist or a desired selection request from a user). If a pending selection is found, then it is played in step 48 and a return is made to step 47. If there is no pending selection, then a return is made to step 45 to determine whether continuous play mode has been commanded.

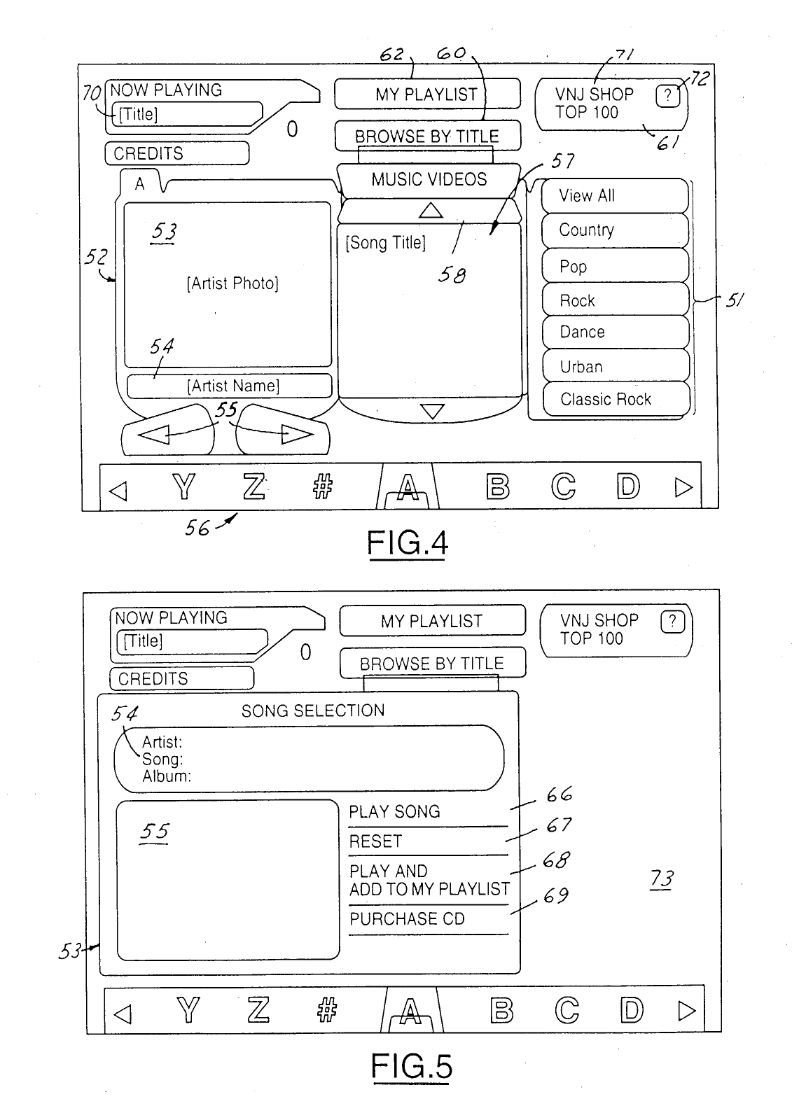

FIG. 4 shows a touch screen user interface wherein a user is able to browse a set of video selections and choose a desired video selection for display by the large-area display system (or by an auxiliary display just for the user and not for the entire premises, if so configured). After a user establishes credits by inserting currency or a credit card into a payment acceptor, the number of established credits is displayed in a credit window 50. The displayed number preferably flashes to emphasize that a desired selection can be entered. Selection may begin with selection of a music genre from a genre bank 51 or may begin with a default genre selection of “View All.” If a genre is selected, then only the song titles or artist names in that category are searched.

The user interface initially defaults to a search for the desired artist name. An artist selection tool 52 includes a picture window 53, a text window 54, and scrolling arrows 55. Arrows 55 may be used to scroll alphabetically through names of artists corresponding to the selected genre which are in the customized set of available selections. The user can jump to names beginning with a particular character using an alphabet bar 56 at the bottom of the touch screen.

For an artist shown in picture window 53 and text window 54, the corresponding song titles that are currently available are shown in a song title window 57. If all the available titles for an artist do not fit in window 57, then the song titles can be scrolled using scrolling arrows 58. When a desired song title is visible, it is touched on the touch screen display in order to select it and to initiate a corresponding request to the jukebox server.

Rather than searching by artist name, searching can be performed by song title by pressing a browse-by-title button 60. All titles or titles by genre then appear in song title window 57. The user can jump to song titles beginning with a particular character using alphabet bar 56.

Browsing of artist names and/or song titles can also be performed by activating a top-100 button 61 which presents a listing of the 100 most frequently played selections from that jukebox client, for example. By providing user identification (e.g., by providing the ability to input a name and a password or determined automatically in response to a credit card used to establish credits), a personal playlist of previously played selections can be retrieved using a my-playlist button 62.

When a song title is pressed, a confirmation window 63 appears as is shown in FIG. 5. A text window 64 shows the artist name, song title, and album name of the chosen selection and a picture window 65 shows a picture of the corresponding CD cover or artist photograph, for example. A button 66 can be activated to request playing of the video/audio selection. If the selection shown is not the desired selection, then a reset button 67 can be activated and the interface returns to the selection screen. In order to play the selection and add it to the personal playlist, then a button 68 is activated.

An integrated CD vending service can be incorporated into the commercial enterprise, such as by providing a CD burner associated with the jukebox server or the jukebox client or by placing an order using the Internet to be processed elsewhere. If the user has sufficient credits, then he can request purchase of a CD (either an entire album or a single song) by pressing a button 69.

An immediate play button (not shown) can also be provided in order to provide a higher priority for playing a desired selection when incorporating it into the selection queue of the jukebox server (for an extra charge).

An advertisement window 73 within the confirmation window provides a further opportunity to show ads to the user, such as an ad and pricing information for purchasing a CD having the desired selection thereon.

Returning to FIG. 4, a “now playing” window 70 displays the title of a selection being played at the jukebox client station and/or at the large-area display. A “shop” button 71 may be selected to bring up a vending interface for making purchases. A “help” button 72 may be activated in order to receive on-screen help messages.

By providing additional support interfaces as described below and by customization of sets of video/audio selections available, the present invention provides an integrated business solution with a variety of functions and features, including the following.

### Entertainment Manager Mode

This mode allows a business establishment to adopt a theme for the entertainment or atmosphere of the premises. For example, the establishment may be a dance club or a sports bar and the customized theme provides video selections according to those themes, such as dance music videos or sports programming, respectively. Themes may be semi-permanent or may be tied to special events or holidays (e.g., ethnic music such as Jamaican music on a tropics night or Irish music on St. Patrick's Day, sports selections during a sports playoff, karaoke video selections on a Karaoke night, or movie selections during special movie events such as the announcement of Oscar Award nominations). The special themes may be implemented without removal or replacement of the multimedia selections stored in connection with the jukebox server by specifying a filter that limits the available selections to those matching the theme.

### Digital DJ

The digital DJ mode provides customized playlists of selections within the total multimedia content that is available. The playlists may be organized according to predetermined start times and/or dates as desired by those operating the commercial enterprise. The customized playlists play continuously unless a customer purchases a selection, although any purchased selection can only be chosen from the predetermined, customized set. The digital video jukebox network can be programmed to accept user selections with or without purchased credits, or for insertion into the currently pending selection queue at a priority level commensurate with a payment amount, for example.

### Performer Rotation Manager

For nightclubs providing live entertainment by live performers in rotation (e.g., standup comics, professional dancers, singers, etc.), a jukebox client having a live performer interface is provided. If performers are required to pay a fee to the business establishment, then a payment acceptor interacts with the live performer interface to collect the fee. Presented by the live performer interface is a customized set of video selections that may be provided for the type of performance in general or a coordinated playlist for the individual performer can be set up in advance. The set of video selections may include a prerecorded audiovisual announcement for an event or for an individual performer. If the performer is scheduled to appear at specific times, then the announcement can be generated automatically at the designated time.

### Time Clock Mode

For establishments with hourly employees, an application is provided for keeping track of hours worked by individual employees. An employee interface is preferably presented via the touch screen so that an employee can select their name to sign in and sign out. The information is collected and reported by the jukebox network to the management of the business establishment.

### Cash Register Mode

A user can access a vending interface for browsing a selection of available goods and for choosing a desired good to be purchased from the commercial enterprise. After receiving a corresponding payment via the payment acceptor, the jukebox client transmits a request for the desired good to the jukebox server which interfaces to either manual or automated delivery systems (e.g., a counter clerk or one or several vending machines).

### Security System Mode

Using the video camera attached to jukebox clients, live video images of the premises are captured and can be transmitted to security personnel or to business owners/managers locally within the premises or remotely via the Internet connection. A password protected website can be established so that the premises can be remotely viewed by the business owner from anywhere that Internet access is available. The video camera can be provided with remote control for remotely panning a video camera or adjusting a view.

### Digital Broadcasting Network Mode

By virtue of the Internet connection, not only can Internet browsing be made available to a user of the jukebox clients, but multipoint digital video broadcasts distributed over the Internet can be received and displayed by the jukebox server. These broadcasts can include pay-per-view events or sporting events. If initiated by a customer, then payment for an event can be obtained from the customer.

### Advertising Mode

Via auxiliary displays attached to jukebox clients or the large-area displays attached to the jukebox server, various advertising videos and/or audios are presented to patrons of the business establishment. Upcoming events in the establishment can be advertised, or advertising time can be sold to advertisers wanting to reach the viewer base in the business establishment. The advertisements can be shown interspersed with video selections or in predetermined time slots.

Jukebox server 11 is shown in greater detail in FIG. 6. A main microcontroller is (e.g., on a motherboard) is coupled to a network interface 76 to exchange network traffic in a LAN configuration with the jukebox clients and in a WAN configuration with an Internet connection. An input/output (I/O) block 77 interfaces between microcontroller 75 and peripheral devices such as a keyboard and mouse 78, printer 79, sound system 17, and displays 16 and 20. Video content storage 80 includes the removable hard drives mentioned previously for storing the multimedia files. A customizer 81 is programmed to filter predetermined subsets of the files in storage 80 (i.e., limit availability to only those selections within a predetermined theme or DJ-created playlist). Jukebox server 11 includes a selection queue 82 that identifies selections to be played. Frequent users may create personal playlists that are stored in user storage 83.

In connection with the time clock mode of operation, a time clock module 84 maintains employee lists including ID's, passwords, and hours worked.

In connection with the cash register mode, a vending module 85 is provided for controlling the distribution of goods based on interaction with a jukebox client from which a user initiates a purchasing transaction. The client identifies a selected good, verifies sufficient payment, and transmits an authorization to the jukebox server which provides centralized control of vending machines 86, for example. The server or client may alternatively notify a human clerk of a purchase, with the clerk delivering the selected goods.

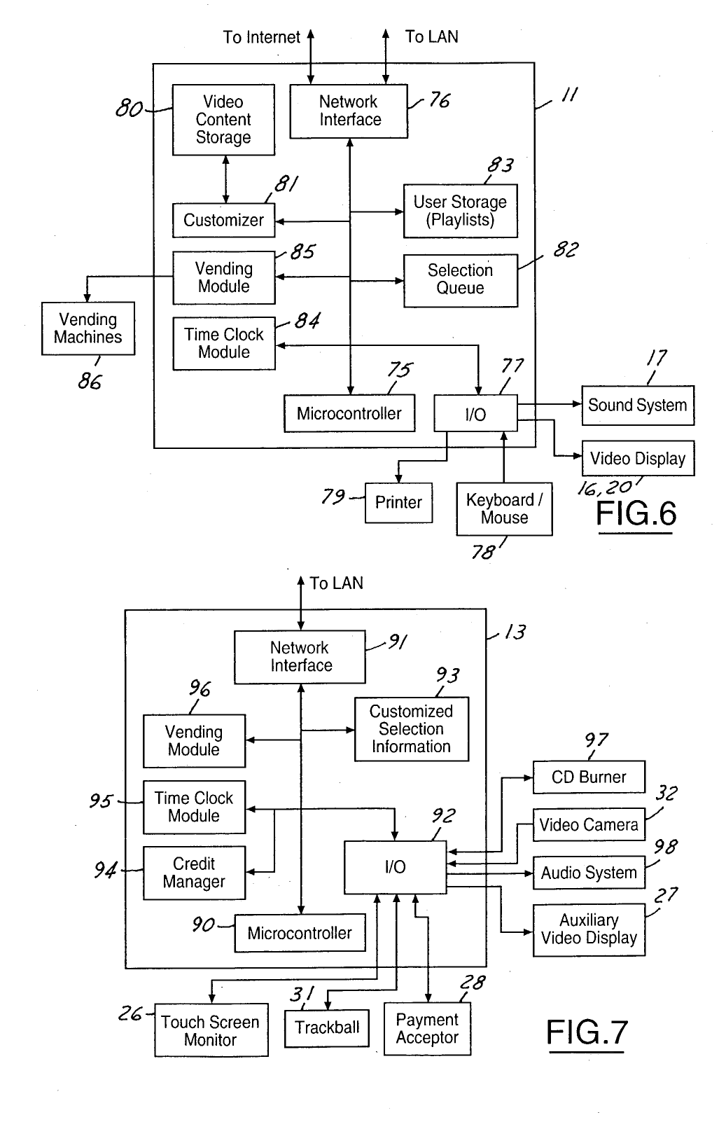

A jukebox client 13 is shown in greater detail in FIG. 7. A main controller 90 is coupled to a network interface 91 and a peripheral I/O interface 92. Customized selection information 93 is used in presenting a user interface on touch screen monitor 26 by defining the functionality of the interface and providing details about the video selections obtained from the jukebox server.

A credit manager module 94 interfaces with payment acceptor 28 for accounting for credits established and used at the jukebox client. For credit card use, a dial-up modem connection may provide credit verification and authorization.

A time clock module 95 can be activated in the time clock mode so that the employee interface is presented on touch screen 26. Module 95 forwards sign in or sign out activity to the time clock module in the jukebox server.

A vending module 96 is provided for generating the vending interface which presents available goods selections to a user, processes payments, and may send purchase authorizations to the jukebox server if goods are not being delivered by the jukebox client itself. One type of goods that may be provided is a recording of a videos or audio selection. Thus, a CD burner 97 can be activated by vending module 96 to create a CD of the selection, for delivery to the customer.

In addition to auxiliary display 27, an audio system 98 is coupled to client 13 to reproduce video selections and/or advertisements shown by client 13.

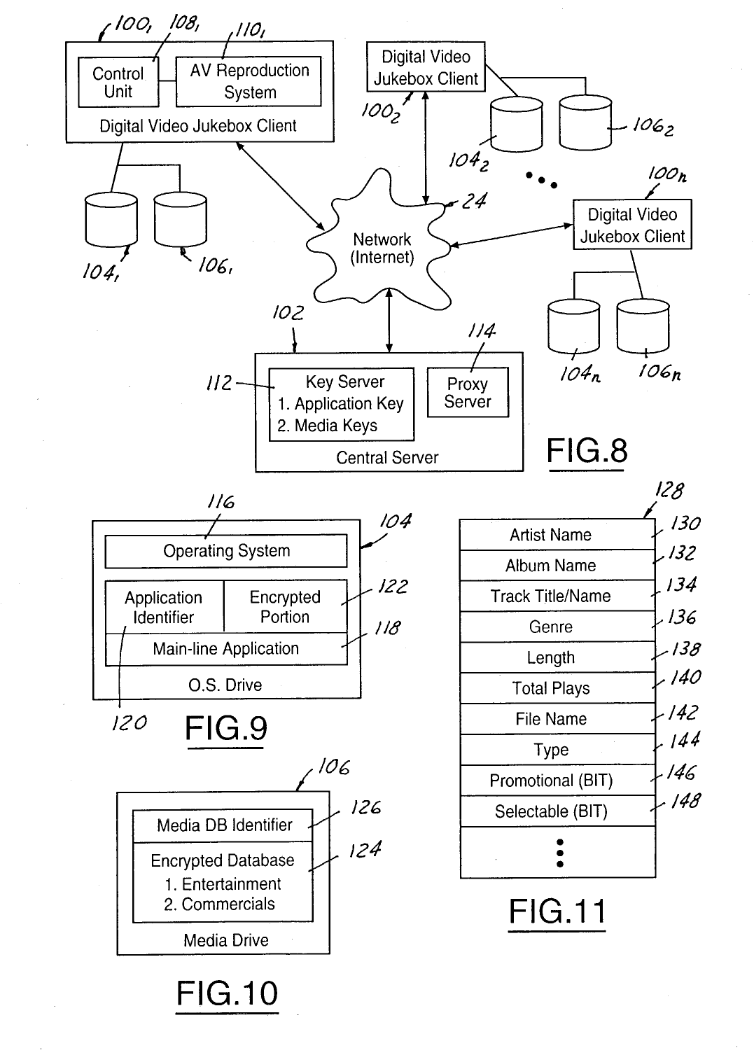

FIG. 8 shows another embodiment in accordance with the present invention, which may include a plurality of digital video jukebox clients, designated 100₁, 100₂, . . . , 100ₙ. Digital video jukebox clients 100₁, 100₂, . . . , 100ₙ are in communication with a central jukebox server 102 by way of a network, such as a wide area network 24 (e.g., Internet). This connection to network 24 may be made through conventional access media/protocols known to those of ordinary skill in the art (e.g., Ethernet, USB, Dial-Up, etc.). In one embodiment, each jukebox client 100₁, 100₂, . . . , 100ₙ is configured to establish a Virtual Private Network (VPN) to server 102 for communications therebetween. Other communication arrangements, however, are possible, and would remain within the spirit and scope of the present invention.

In the illustrated embodiment, each jukebox client 100₁, 100₂, . . . , 100ₙ has a respective operating system (OS) drive 104 associated therewith, one or more media drives 106 associated therewith, a control unit 108 and an audiovisual reproduction system 110. It should be understood that unless specifically stated otherwise, each client 100₁, 100₂, . . . , 100n includes at least the functionality described above in connection with jukebox 10.

In addition, it should be specifically understood that unless stated to the contrary, the term “audiovisual” means (i) combined video and audio content; (ii) video only content; and (iii) audio only content. In constructed embodiments, however, most of the content comprises combined video and audio content.

Moreover, each jukebox client 100₁, 100₂, . . . , 100n is configured to perform further functions, for example, to implement dynamic commercial scheduling, security and library profiling, all to be described in greater detail hereinafter.

In the illustrated embodiment, each jukebox client 100₁, 100₂, . . . , 100ₙ may be located at respective business establishments, as described above in connection with jukebox 10. In FIG. 8, otherwise identical components associated with individual ones of the plurality of jukebox clients are designated by the same reference numeral, but have a different subscript, namely, a subscript corresponding to its number in the plurality (e.g., “1,” “2,” . . . “n”). The control unit 108 and the AV reproduction system 110 have been omitted from jukebox clients 1002, . . . , 100n for clarity.

In FIG. 8, server 102 is shown to include a key server 112 and a proxy server 114. Key server 112 is provided to facilitate enforcement of security for both the jukebox clients 100₁, 100₂, . . . , 100ₙ as well as for the audiovisual content that each of the jukebox clients may contain. Key server 112 is configured to provide two types of keys. The first type of key will be referred to as an application key, and is used by jukebox client as a first level of authentication and security, and will be described in greater below. The second type of key provided by key server 112 will be referred to as a media key. One or more media keys may be associated with each jukebox client 100₁, 100₂, . . . , 100ₙ depending upon the number of media drives 106 included in any particular jukebox client 100₁, 100₂, . . . , 100ₙ. This is a second level of authentication and security in accordance with the present invention.

Proxy server 114 is configured for establishing connections to the Internet originating from jukebox clients 100₁, 100₂, . . . , 100ₙ so equipped with Internet browsing capability. Through the foregoing, it should be appreciated that end-users of jukebox client 100 preferably do not have direct access to Internet 24, but rather only indirect access through proxy cache server 114. Browsing capabilities on jukebox clients so equipped, in one embodiment, are characterized by reduced functionality as compared to generally commercially available browsers (e.g., downloads and attachments would not be allowed, certain scripting capabilities would also be disabled, etc.). Proxy server 114 is further configured, however, to permit secure HTTP connections, for example, to allow on-line shopping from jukebox clients 100₁, 100₂, . . . , 100ₙ.

FIG. 9 shows operating system (OS) drive 104 in greater detail. OS drive 104 provides non-volatile storage for an operating system upon which an embodiment of the inventive jukebox may be constructed. OS drive 104 may include an operating system 116, a main-line application program 118, an application program identifier 120 and an encrypted portion 122.

Operating system 116 may comprise conventional, commercially available software known to those of ordinary skill in the art, for example, Free BSD (unix variant), a WINDOWS brand operating system, or a LINUX type operating system.

Main-Line application program 118 comprises the software routines described in greater detail herein that provide the inventive functionality for a digital video jukebox. For example, execution of the application program 118 by the underlying computing hardware provides many of the functions described for control unit 108.

Application identifier 120 comprises information that uniquely identifies both the application program 118, but also the particular one of the plurality of jukebox clients 100₁, 100₂, . . . , 100n. The identifier 120, as described in greater detail below, provides the identification that each jukebox client needs to provide for authentication purposes.

Encrypted portion 122 comprises information, such as data or the like, that application program 118 needs to continue running beyond an initial stage. However, the default state for this information 122 is an encrypted state. Therefore, unless application program 118 can authenticate the particular client 100₁, 100₂, . . . , 100ₙ with key server 112 using application identifier 120, and otherwise show entitlement to obtain an application key configured to decrypt the normally encrypted information 122, application program 118 will not execute beyond an initial stage. This is, of course, because the needed data contained in portion 122 cannot be decrypted.

FIG. 10 shows media drive 106 in greater detail, including a database 124 containing a plurality of audiovisual items in digital form and a media database identifier 126. Database 124 includes at least (i) a first portion containing commercials, advertisements, announcements or the like, and (ii) a second portion containing entertainment such as music videos and the like. It should be understood that the description of one database having first and second portions is exemplary only, not limiting in nature, and is made for clarity in explanation only. No actual segregation need exist in database 124 between the commercials and the entertainment. Moreover, two separate databases may be implemented with equal effectiveness, and is hereby expressly within the spirit and scope of the present invention. Thus, the terms database having first and second portions is meant to include all of the foregoing alternatives as well as equivalents thereof. As described above, the particular digital format may comprise any format now known to one of ordinary skill in the art, or hereafter discovered or developed. In one embodiment, the video portion of the audiovisual items may be encoded in accordance with MPEG 1—Layer II (720×480 pixels) and the audio encoded at a 128-bit rate in stereo in accordance with MPEG 1—Layer I.

Database 124 is encrypted, in its default state. Accordingly, the audiovisual content contained therein will be inaccessible by control unit 108 (e.g., for reproduction by jukebox 100) unless a corresponding media key can be obtained from key server 112 using media database identifier 126. Moreover, the content is protected from misuse, since it is useless unless decrypted.

The audiovisual items contained in the first portion of database 124 may be “paid for” advertisements relating to artists, in-house promotions for particular vendors (e.g., certain brewers, cigarette companies, etc.), particular artists and even local announcements, which may be free of charge to the operator of jukebox client(s) 100₁, 100₂, . . . , 100ₙ.

FIG. 11 is a simplified representation of a record or header 128 for an audiovisual item contained in the second portion of database 124 (i.e., entertainment). Header 128 includes a plurality of fields, including an artist name field 130, an album name 132, a track or title name 134, a genre 136, a length 138, a total number of plays 140, a filename 142, a type 144, a promotional play field 146 and a selectable field 148.

Name, album and track fields 130, 132 and 134 are self-explanatory. Genre field 136 lists the genre in which the particular audiovisual item is most closely related. For example, the screen display in FIG. 4 shows some exemplary genres like COUNTRY, POP, ROCK, DANCE, URBAN and CLASSIC ROCK. Of course, other genres are possible, and still remain within the spirit and scope of the present invention. Length field 138 contains a value indicative of the uncompressed runtime length of the audiovisual item.

Total plays field 140 includes a value indicative of the number of times an end-user has selected this particular audiovisual item for reproduction. This field, ineffect, constitutes a counter, which may be used in allocating royalties to copyright holders or the like.

The filename field 142 contains the name of the file that contains the actual audiovisual payload corresponding to the header 128.

The type field 144 indicates whether the corresponding content is combined video and audio, or audio only.

Promotional field 146 and selectable field 148 together define attributes of the audiovisual items contained in the database 124. Of course, in other embodiments, additional “bits,” such as random play, etc. may be provided for and remain within the spirit and scope of the invention. Referring to the plurality of audiovisual items in database 124 as a library, the fields 146 and 148 enable “library profiling” in accordance with the present invention. This library profiling feature associates multiple attributes with each audiovisual item available in database 124. For example, each attribute may be a “bit,” one bit to indicate “Promotional” such as in field 146 and a second bit to indicate “Selectable” as in field 148. If neither bit is set (both “0”), then the audiovisual item is unavailable. If the “Selectable” bit is “1,” and “Promotional” is “0,” then the audiovisual item may be selected by the end-user of jukebox client 100 for playback, for example via a payment, but will suppressed from being played randomly (e.g., randomly selected when no “pay for play” selections are in the playlist queue). If the “Promotional” bit is “1” and the “Selectable” bit is “0,” then the audiovisual item may be played by jukebox client 100 during a random play mode but cannot be selected for play via purchase by an end-user. If both bits are set (“1”), then the audiovisual item can be both selected by an end-user, and selected by control unit 108 for random play in accordance with predetermined criteria. Generally, “library profiling” provides the ability to restrict or otherwise limit what content can be selected and/or played based such attributes (e.g., “Promotional” and “Selectable” fields 146 and 148 respectively).

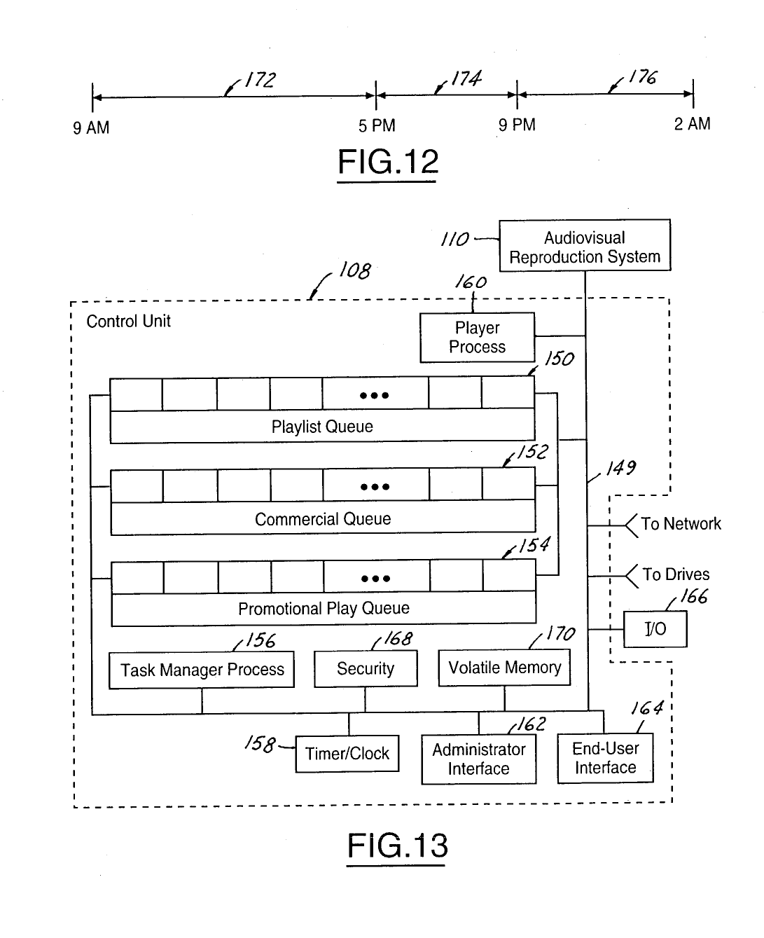

FIG. 12 shows an example of one application of “library profiling” in accordance with the present invention. For example, between 9 AM and 5 PM, a first profile 172 may be defined as a “family” profile. The family profile may limit audiovisual material to “pop” genre. Between 5 PM and 9 PM, a second profile 174 may be defined, for example, a “dinner” crowd profile. The dinner crowd profile may limit audiovisual material to light jazz material. Between 9 PM and 2 AM, a third profile 176 may be defined as a “dance” profile. The dance profile may limit audiovisual material to “dance” genre items. Jukebox client 100 provides an interface, to be described in greater detail hereinafter, that facilitates the setting up of a “profile”. In sum, such interface allows, for example, an administrator to search the universe of all audiovisual items on all possible criteria, including but not limited to genre, artist, or even a particular title, to include or exclude from the profile being setup. Such interface, in a preferred embodiment, further allows specification of when the actual time of day reaches the profile start time (i.e., the time the profile is to take effect). When the profile is to take effect, a task manager process, to be described below, adjusts the bit in the “selectable” field 148 in compliance with the profile (e.g., making only “dance” genre items selectable during the “dance” profile, but no others). Setting the bit makes it visible to the end-user, and thus available for selection. This is different than a predetermined playlist as known in the art, inasmuch as an administrator defines what audiovisual items are visible to and available for selection by the end-user.

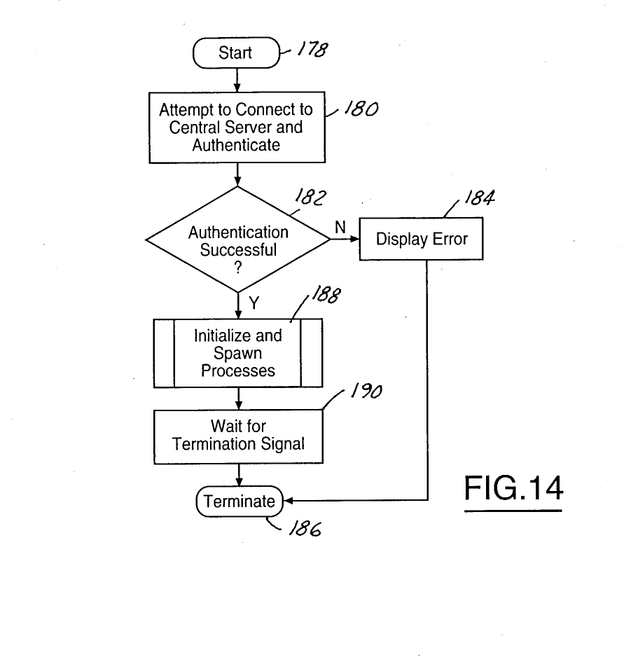

FIG. 13 is a simplified block diagram view of the control unit 108 of FIG. 8. Although not shown specifically, it should be understood that control unit 108 comprises conventional computing hardware such a central processing unit (CPU), main memory (e.g., RAM, ROM), input/output (I/O) for communicating with the outside world, and the like. Control unit 108 includes a common bus 149, a playlist queue 150, a commercial queue 152, a promotional play queue 154, a task manager process 156, a timer/real-time clock 158, a player process 160, a first, administrator interface 162, a second, end-user interface 164, input/output (I/O) 166, a security process 168 and volatile memory 170.

Common bus 149 is configured to allow communication between and among the various components shown in FIG. 13. It should be understood, however, that bus 149 need not be a physical bus (although it may include a physical bus). For example, some of the components shown in FIG. 13 are software processes, in which case the common bus 149 may be a inter-process communication capability provided in operating system 116.

Playlist queue 150 is configured to contain a plurality of entries. Each entry may include the identification of an audiovisual item to be reproduced, a timestamp indicating a time when the entry was placed in the queue, and a priority value. As between entries having the same priority value, playlist queue 150 is configured as a first-in, first-out (FIFO) queue, with the timestamp indicating the order of reproduction. In one embodiment, each audiovisual item selected by an end-user for reproduction is assigned an initial priority value (e.g., “1”). However, the priority value of an item may be altered, for example, by paying extra money, which may elevate that item's priority from a “1” to a “2”. Other variations, however, are possible, and remain within the spirit and scope of the present invention.

Commercial queue 152 is configured to contain a plurality of entries. Each entry may include the identification of a commercial, advertisement, announcement or the like to be reproduced. The commercial queue 152, in the illustrated embodiment, has priority over the playlist queue 150 and the promotional play queue 154 to be described. In particular, the player process 160 to be described in detail below first checks the commercial queue to determine whether there are any commercial items to be reproduced, and will continue to work off of the commercial queue 152 until it is empty, before moving on to check the playlist queue 150 for any item to be reproduced

Promotional play queue 154 is configured to contain a plurality of entries. Each entry may include an identification of the audiovisual item to be reproduced by the jukebox client 100. The promotional play queue 154 is provided to hold audiovisual items specifically designated for reproduction when the jukebox client 100 is in a promotional mode (i.e., no paid-for items or commercial items queued up).

Task manager process 156 is configured to perform a variety of tasks to implement jukebox client 100. Process 156 is configured to place commercials, advertisements, announcements or the like in the commercial queue 154, perhaps at a specified time. For this function, task manager process may be triggered into such action by timer/clock 158.

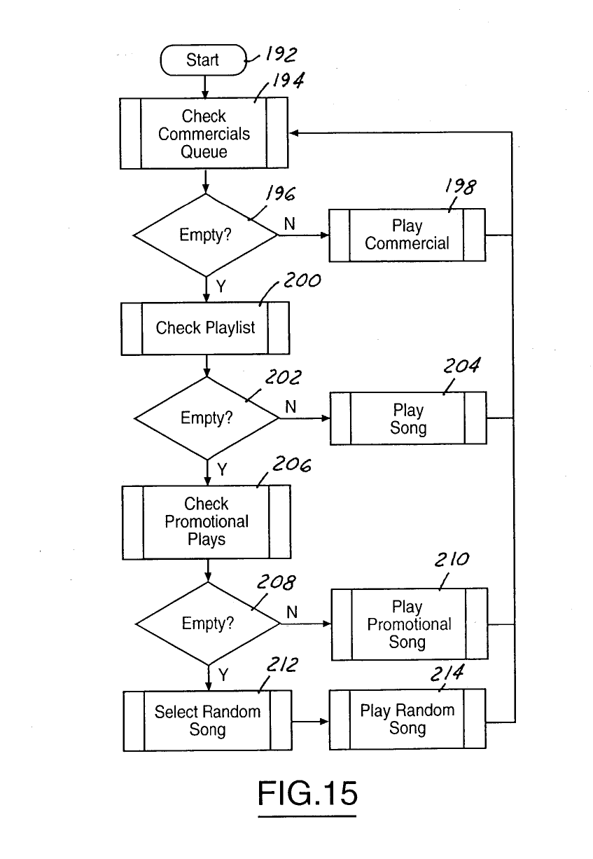

Player process 160 is configured to playback or otherwise reproduce audiovisual items from digital form to a human perceptible form through AV reproduction system 110. For example, player process 160 may include decoders consistent with the variety of encoding/compression schemes known in the art (e.g., MPEG). Player process 160 is configured to check the commercial queue 152, the playlist queue 150 and the promotional play queue 154, preferably in that order, and reproduce the audiovisual items it identifies. Player process 160 is also configured to select audiovisual items in a quasi-random fashion when none of the queues contain any items. The foregoing and other functionality of player process 160 will be described in greater detail in connection with FIG. 15.

Administrator interface 162 is configured to allow a proprietor of a business establishment or the like to setup various features of jukebox client 100. One such feature is library profiling. Interface 162 may execute through I/O 166, which itself may comprise conventional human input and output apparatus known to those of ordinary skill in the art (e.g., mouse, keyboard, touch-screen, etc.). Interface 162 provides the capability to sort the universe of audiovisual items, for example, by genre. The interface 162 also provides the capability to segregate each day into discrete time periods, wherein in each time period, a different attribute profile can be applied. In combination, these features allow tailoring of the audiovisual items based on parameters such as (i) the time of day; and (2) genre of the video, and (3) whether the item is paid or random play. The benefit of this feature is that it provides the proprietor (administrator) the ability to tailor the content suitable for the time, place, etc. (e.g., dance time starts at 5 PM, so you only want dance music at that time).

Interface 162 is thus configured for allowing input of selection parameters (e.g., searching and sorting parameters) from the administrator and displaying the resulting audiovisual items on a display drawn from all available of audiovisual items. Interface 162 is further configured to allow the administrator to designate which ones, if any, of the displayed audiovisual items are permitted to selected for reproduction by the end-user. In this regard, the interface 162 is configured to facilitate either the setting or the clearing of the “selectable” bit (i.e., field 148 in FIG. 11) and/or the “promotional” bit (i.e., field 146 in FIG. 11). The foregoing establishes a profile, which is in turn based on attributes defined by the “selectable” and “promotional” bits, in this instance. In an alternate embodiment, interface 162 may be further configured to receive time interval information, and associate the administrator's designations with a time period. Thus, as described above in connection with FIG. 12, one jukebox client 100 may be programmed to include a variety of “Profiles” suitable for time, day of the week, etc.

Interface 162 also facilitates implementation of a dynamic commercial scheduling feature. For this feature, interface 162 provides a mechanism through which the administrator (or business proprietor) may select a commercial, advertisement, announcement or the like from a portion of database 124 containing commercials, and to associate a specific time at which the selected commercial is to be reproduced by jukebox client 100. Other approaches are possible. You can specify a single one-time occurrence, multiple occurrences over a range of days or minutes, or multiple occurrences during specific times of the week. The invention allows the schedule for any particular media to be modified at any time. And commercials can be added or removed on an individual basis. The invention can also contain an infinite number of commercials with an infinite number of associated schedules; the only practical limit is data storage for the commercial media. Once this information has been received, control unit 108, through the task manager process 156 and the player process 160, is configured to reproduce the selected commercial item at approximately the specified time. It should be understood that the term “approximately” allows for the possibility that an audiovisual item may be in the process of being reproduced when the specified time arrives. In one embodiment, the audiovisual item is not interrupted, but rather is allowed to finish prior to the reproduction of the commercial or the like. Interface 162 is also configured to allow removal of a commercial from the schedule dynamically. In addition, interface 162 may be accessed remotely to remotely setup a particular jukebox client 100.

The administrator's interface 162 may be used remotely (i.e., over network 24), provided authentication is made prior to access.

End-user interface 164 is configured primarily for interaction with end-user's (e.g., patrons, customers or the like) rather than an administrator, business proprietor or the like. Interface 164 is configured for allowing input of selection parameters (e.g., search and/or sorting parameters) from the end-user and displaying the resulting audiovisual items on a display. The resulting audiovisual items are thus drawn from the plurality of audiovisual items that meet both (i) the selection parameters specified by the end-user; and (ii) that have the “selectable” bit set indicating the audiovisual item may be selected for reproduction by the end-user. For example, the interface 164 may allow searching based on genre, artist name, album name, or any other of the fields set forth in record 128 illustrated in FIG. 11. Interface 164 is further configured to allow the end-user to select a particular audiovisual item from the those displayed, as described above, for ultimate reproduction by the jukebox client 100. In a preferred embodiment, interface 164 is configured such that the end-user's selection will not take effect unless the appropriate credits (e.g., payment) has been made and registered on jukebox client 100. Interface 164, working with other processes executing in jukebox client 100, is operative to timestamp the selected audiovisual item and place it in the playlist queue 150. The control unit, by way of the player process 160 and AV reproduction system 110, is configured to reproduce the enduser's selected audiovisual items.

Security module 168 and volatile memory 170 are configured to protect the integrity of both the jukebox client 100 itself, as well at the media stored on media drive(s) 106. In this regard, the security module 168 is operative to communicate with central server 102 to authenticate the jukebox client at two-levels before allowing access to the audiovisual content. At the first level, the jukebox client 100 is itself authenticated. At the second level, the media drive(s) are authenticated prior to access. Encryption is used to enforce the security. A detailed description of the security established by the present invention will be set forth below in connection with FIG. 14.

With continued reference to FIG. 13, audiovisual reproduction system 110 is configured to convert audiovisual items in digital form to a human perceptible form. For example only, system 110 may include those items described above in connection with jukebox 10, such a large-screen television monitor, an audio card, and a loudspeaker system, among other items. Generally, system 110 may comprise conventional apparatus known to those of ordinary skill in the art.

FIG. 14 is flowchart of an initial authentication and security process in accordance with the present invention. The authentication/security occurs at two levels: The first level is an application program check. The second level is directed towards protection of the audiovisual content stored in database 124. The method begins in step 178, and proceeds to step 180.

In step 180, the main-line application program 118, particularly a communications module thereof, begins to execute, which includes the step of attempting to establish a communications link with central server 102. If such a communications link, for example a virtual private network (VPN), cannot be established, then the execution of application program 118 is discontinued and jukebox client 100 cannot achieve a fully functional state. If communications can be established, however, then processing will continue via execution of the security module 168. Security module will attempt authentication with server 102. As described above, the mainline application program 118, including security module 168, resides on an unencrypted portion of OS drive 104. Security module 168 attempts authentication using application identifier 120, which is unique to the particular jukebox client 100. If the server 102 accepts the application identifier 120, and determines that this particular jukebox client 100 is entitled to operate, then server 102 transmits an application key to the jukebox client 100. If the application authentication fails, or server otherwise determines that the jukebox client is not entitled to operate, then the request for the application key is refused. For example, if the jukebox client 100 is stolen, then the proprietor may report such theft, which information is updated on server 102. Then, if the stolen jukebox client 100 is powered up, and a connection is attempted to server 102, then server 102 will recognize the jukebox client 100 as stolen and, notwithstanding the fact that perhaps the application identifier 120 checks out, nonetheless determine that no entitlement is in order, and refuse to grant the application key. The method proceeds to step 182.

In step 182, security module 168 checks to determine whether the authentication was successful. With the application key, security module 168 can decrypt the encrypted portion 122 required for continued processing. Otherwise, without the application key, the application stops. If the authentication fails, then the method branches to step 184. Otherwise, control passes to step 188.

In step 184, jukebox client 100 displays an error, and the processing is terminated in step 186.

In step 188, other processes are initialized and spawned. For example, a process is initialized that involves discovery of media drives 106. In this regard, security module 168 is configured to transmit media database identifier 126 and other relevant information regarding media drive 106 to server 102 for authentication, and retrieval of a media key. Using the media key, security module 168 is configured to decrypt the encrypted database 124. Such discovery process continues until all media drives 106 attached to jukebox 100 are identified, and requests for the corresponding media keys have been made. The method proceeds to step 190. Through the foregoing two levels of authentication, integrity of both the jukebox and of its audiovisual content can be maintained.

In step 190 the application program 118 waits for a termination signal, indicating that processes are to be shut down. When such a signal is received, then control passes to step 186, where the execution terminates.

FIG. 15 is a flowchart showing the execution of player process 160. The method starts in step 192, and proceeds to step 194.

In step 194, the player process 160 checks to determine whether there are any audiovisual items in the commercial queue 152. The method proceeds to step 196.

In step 196, the player process 160 determines whether the commercial queue 152 is empty. If NO, then the method branches to step 198. In step 198, the player process 160 plays the highest priority commercial audiovisual item in the commercial queue 152. After the player process 160 effects the reproduction of the commercial item from digital form to a human perceptible form (via AV reproduction system 110), control passes to step 194. The method steps 194, 196 and 198 are repeated until the commercial queue 152 is emptied. If (or when) the commercial queue 152 is empty, then control passes to step 200.

In step 200, the player process 160 checks the playlist queue 150. The method proceeds to step 202.

In step 202, the player process 160 determines whether the playlist queue 150 is empty. If NO, then the method branches to step 204 wherein the player process 160 effects reproduction of the audiovisual item from digital form to a human perceptible form (via AV reproduction system 110). Control then passes to step 194. Otherwise, if the answer to inquiry in step 202 is YES, then the method branches to step 206.

In step 206, player process 160 checks to determine whether there are any audiovisual items in the promotional play queue 154. The method proceeds to step 208.

In step 208, the player process 160 checks to determine whether the promotional play queue is empty. If NO, then the method branches to step 210. In step 210, the player process 160 effects reproduction of the audiovisual item from digital form to a human perceptible form (via AV reproduction system 110). Control then passes to step 194. Otherwise, if the answer to the inquiry in step 208 is YES, then the method branches to step 212.

In step 212, player process 160 selects, in a quasi-random fashion, an audiovisual item from database 124. In accordance with another aspect of the present invention, the player process 160 intelligently selects an audiovisual item from database 124 based on predetermined criteria. The predetermined criteria may include, as taken with respect to a candidate audiovisual item, (i) a time interval since the candidate audiovisual item was last reproduced, either as taken from the playlist queue or otherwise (e.g., in a previously executed step 212); (ii) an identity of a copyright holder in and to the candidate audiovisual item; (iii) whether or not the candidate audiovisual item is in the “top” predetermined number of audiovisual (e.g., 100 items). The first item above may be considered inasmuch as the idle time is an opportunity to play new audiovisual items, thereby exposing patrons to new media. Reproducing an audiovisual item recently selected by an end-user, or the via step 212 reduces the effect of introducing new media. The second item above may be considered inasmuch as some copyright holders exercise their rights and charge a royalty whenever the audiovisual item is reproduced, regardless of whether the proprietor of the jukebox received any money from the end-user (i.e., they charge whether or not it is a “random” play or a paid-play). The second item provides a mechanism in which the jukebox proprietor can increase profitability by excluding those audiovisual items from random play that carry a fee. The third item above may be considered inasmuch as playing one of the “top” songs randomly may satisfy the interest of some end-users, resulting in a lost “pay for play” selection. In any event, once the audiovisual item has been “randomly” selected in step 212, control is passed to step 214.

In step 214, the player process 160 causes the audiovisual item to reproduced (e.g., via AV reproduction system 110). The method then proceeds to step 194 wherein the player process 160 as described above is repeated.

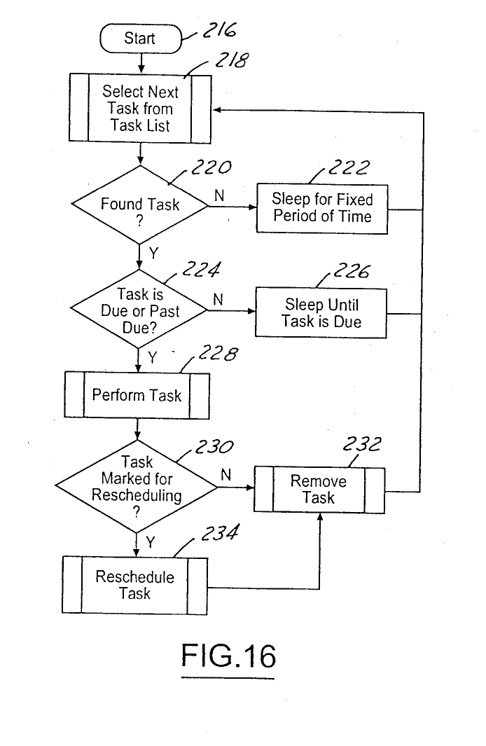

FIG. 16 is a flowchart diagram of a task manager process 156, showing in greater details substeps thereof. The process 156 begins in step 216, and then proceeds to step 218.

In step 218, the task manager process selects the next task from the task list. Tasks may include a time-triggered entry of a commercial, advertisement, announcement or the like into the commercial queue 152. Another task is the updating of the “selectable” and “promotional” bits (i.e., fields 146 and 148 in FIG. 11). In this regard, the task manager process 156 is configured to update the records associated with audiovisual items in database 124 when a time of day reaches a profile start time. The process of setting up a “profile” was described above in connection with the administrator interface 162. To implement the “profile” however, the task manager process 156 is configured to update the “promotional” and “selectable” bits when the profile start time arrives. Thereafter, searches conducted by end-users of jukebox client will not be given an opportunity to select an audiovisual item unless the “selectable” bit set (i.e., the item will not be visible unless the “selectable” bit is set). The task of updating the attribute bits may occur a plurality of times per day, depending on whether time-based profiles have been established. The method proceeds to step 220.

In step 220, a check is performed to determine whether a task was found (i.e., are there any pending tasks?). If the answer is NO, then the method branches to step 222.

In step 222, the task manager process “sleeps” for a fixed period of time, unless earlier awakened by an external event or signal. The method then loops back up to step 218.

If, however, the answer to the inquiry in step 220 is YES, then the method branches to step 224. In step 224, the method performs a check to determine whether the task so found on the task list is either due or past due. If the answer to the inquiry in step 224 is NO, then the method branches to step 226, wherein the task manager process “sleeps” until the task is due, unless earlier awakened by an external event or signal. The method then loops back up to step 218.

If, however, the answer to the inquiry in step 224 is YES, then the method branches to step 228. In step 228, the task manager process performs the task that is now due. The method then proceeds to step 230.

In step 230, a check is performed to determine whether the task just completed should be rescheduled to be completed again at a later time. If the answer is NO, then the method branches to step 232, wherein the task is removed from the task list. The method then proceeds to step 218.

If, however, the answer to the inquiry in step 230 is YES, then the method branches to step 234, wherein the task is rescheduled to be completed again at a later time. The method then proceed back to step 218.

1. A jukebox comprising:
a database configured to store a plurality of audiovisual items in digital form, a first portion of said database comprising at least one of an advertisement, a commercial and an announcement; and
a control unit coupled to said database and having a first interface for selecting a first item from said first portion of said database and for specifying a time for reproduction of said selected first item;
said control unit further having a second interface configured to allow selection of audiovisual items for reproduction from a second portion of said database;
said control unit being configured to reproduce said selected first item at approximately said specified time.

2. The jukebox of claim 1 further including an audiovisual reproduction system coupled to said control unit for reproducing audiovisual items from digital form to a perceptible form.

3. The jukebox of claim 1 wherein said control unit includes a playlist queue, a commercial queue, a player process and a task manager process, wherein said second interface is configured to store selections made using said second interface in said playlist queue, said player process being configured to reproduce said audiovisual items in said playlist queue.

4. The jukebox of claim 3 wherein said task manager process is configured to place said selected first item in said commercial queue at said specified time, said player process being configured to (i) check said commercial queue and reproduce audiovisual items identified therein until said commercial queue is empty, and (ii) check said playlist queue and reproduce audiovisual items identified therein.

5. The jukebox of claim 1 wherein said first interface is further configured to allow deselection of said selected first item thereby inhibiting said control unit from reproducing said selected first item at said specified time.

6. The jukebox of claim 4 wherein said control unit further includes a promotional-play queue containing audiovisual items, said task manager process being configured to place an audiovisual item drawn from said first portion of said database comprising at least one of an advertisement, a commercial and an announcement in said commercial queue when a commercial insertion condition exist, said commercial insertion condition exists when said player process reproduces a first predetermined number of audiovisual items taken out of said playlist queue or when said player process reproduces a second predetermined number of audiovisual items taken out of said promotional-play queue, said first predetermined number being greater than said second predetermined number.

7. The jukebox of claim 6 wherein said first predetermined number is five (5) and said second predetermined number is three (3).

8. A jukebox comprising:
a database configured to store a plurality of audiovisual items in digital form, said audiovisual items each having a record associated therewith defining respective attributes, each record including a first field containing a first bit indicative of whether the respective audiovisual item is selectable by a user for reproduction;
a control unit coupled to said database and having an interface for allowing input of selection parameters from the user and displaying audiovisual items on a display drawn from said plurality of audiovisual items (i) in accordance with said selection parameters and (ii) that have said first bit set indicating said audiovisual item may be selected for reproduction by the user, said interface being configured to allow selection from said displayed audiovisual items for reproduction;
said control unit being further configured to reproduce said audiovisual items selected by said user using said interface.

9. The jukebox of claim 8 further including an audiovisual reproduction system coupled to said control unit for reproducing audiovisual items from digital form into a perceptible form.

10. The jukebox of claim 8 wherein said record further includes a second field containing a second bit indicative of whether a respective audiovisual item is allowed to be reproduced in a random play mode.

11. The jukebox of claim 10 wherein said interface is a first interface, said control unit including a second interface configured to facilitate setting or clearing of said first bit thereby defining an administrator's interface.

12. The jukebox of claim 11 wherein said second interface is configured to allow specifying a profile start time when said first bit will be automatically updated.

13. The jukebox of claim 12 wherein said control unit includes a playlist queue, a player process and a task manager process, wherein said task manager process is configured to update said first bit of each record associated with said audiovisual items when a time of day reaches said profile start time, and wherein said first interface is configured to store selected audiovisual items in said playlist queue, said player process being configured to reproduce said audiovisual items in said playlist queue.

14. The jukebox of claim 13 wherein said second interface is further configured to facilitate setting or clearing of said second bit of said record.

15. The jukebox of claim 14 wherein said control unit is further configured to automatically select audiovisual items from said database that have said second bit set indicating that said audiovisual item is available for random play in accordance with predetermined criteria when a commercial queue, a promotional-play queue and said playlist queue are empty.

16. The jukebox of claim 14 wherein said predetermined criteria, as taken with respect to a candidate audiovisual item from said database, include (i) a time interval since said candidate audiovisual item was last reproduced as taken from said playlist queue; and (ii) an identity of a copyright holder in and to said candidate audiovisual item.

17. The jukebox of claim 16 wherein said first and second bits associated with said audiovisual items define a profile.

18. A method of enforcing content security for a jukebox comprising the steps of:
(A) providing a database coupled to said control unit wherein said database includes a plurality of audiovisual items;
(B) providing a unique identifier associated with said database;
(C) encrypting said database;
(D) obtaining a key from a key server over a network based on the unique identifier and maintaining the key in volatile memory; and
(E) decrypting the database including the plurality of audiovisual items using the key to thereby obtain access to the audiovisual items for reproduction thereof.

19. The method of claim 18 wherein said key is a media key, said method further including the steps of, performed prior to said step of obtaining the media key:
encrypting a portion of an application program;
obtaining an application key from the key server based on an unencrypted application identifier;
decrypting the encrypted portion of the application program.

20. The method of claim 19 wherein said steps of encrypting a portion of the application program, obtaining an application key, and decrypting the encrypted portion of the application program, are performed during start-up of the jukebox.

21. The method of claim 19 further including the steps of:
after decrypting the encrypted portion of the application program, discovering one or more media drives each containing a respective, encrypted database having audiovisual items;
obtaining respective media keys for each discovered media drive; and
decrypting the databases for each discovered media drive using respective media keys.

22. The method of claim 21 further including the step of:
powering down the jukebox wherein said media keys stored in said volatile memory are lost.

23. The method of claim 21 further including the steps of:
performing one of adding, removing or exchanging a media drive in the jukebox;
discovering the change in an identification of media drives in the jukebox;
obtaining a further media key when a new media drive is discovered.

24. An integrated video jukebox and entertainment management system for a premises, comprising:
a video jukebox server providing a set of video selections customized to a predetermined commercial enterprise for said premises;
a large-area display system;
a plurality of jukebox clients deployed in said premises and networked with said jukebox server;
a payment acceptor coupled to at least one of said jukebox clients for establishing credits for accessing said video selections; and
a touch screen input device coupled to said one jukebox client for providing a user interface wherein a user is able to browse said set of video selections and choose a desired video selection for display by said large-area display system, said one jukebox client transmitting a request to said jukebox server for displaying said desired video selection if sufficient credits are established.
